(19) United States
(12) Patent Application Publication
(10) Pub. No.: US 2015/0179155 A1
(43) Pub. Date: Jun. 25, 2015

(54) Guitar Support

(71) Applicant: Martin PAUL, Yorkshire (GB)

(72) Inventor: Paul Martin, Leeds (GB)

(21) Appl. No.: 14/423,411

(22) PCT Filed: Aug. 23, 2013
(86) PCT No.: PCT/GB2013/052229

§ 371 Date: Feb. 23, 2015

(30) Foreign Application Priority Data
Aug. 24, 2012 (GB) 1215106.4

(51) Int. Cl. G10G 5/00

(52) U.S. Cl. CPC G10G 5/005

(57) ABSTRACT

A guitar support comprising an attachment carrier and one or more releasable attachment means; the attachment carrier having a fixture adapted to releasably secure a guitar strap to the carrier in use; a leg releasably connectable at a first end to the attachment carrier and connectable at a second end to a base; the base being connectable to the leg by an articulated linkage; the base having an engagement surface configured to engage a musician's thigh in use; the attachment means being adapted to be releasably secured to the body of a guitar so that the weight of a guitar in use may be partially or wholly supported by the base.

### BACKGROUND OF THE INVENTION

1. Field of the Invention

This invention relates to a support for use in enabling a guitarist to hold and play a guitar, particularly but not exclusively for maintaining a good posture.

2. Description of Related Art

Poor posture can cause various physical complaints for guitar players. Vertebral disorders or tendonitis are common, particularly among more senior musicians. Various guitar supports have been proposed, but these may not allow full freedom of movement and practice, particularly for all types of guitars and styles of playing, including classical, flamenco, jazz, acoustic folk and blues styles, electric guitar styles, or when playing bass guitars, ukuleles or smaller guitars. Limited postural benefits, awkwardness of adjustment and lack of flexibility have hindered adoption of such supports among players and performers.

An object of this invention is to provide a guitar support which may be used with a wide variety of guitars, while allowing a player to maintain a tension-free, healthy posture without detracting from the appearance and ease of use of the guitar.

### SUMMARY OF THE INVENTION

According to the present invention, a guitar support comprises: an attachment carrier and one or more releasable attachment means; the attachment carrier having a fixture adapted to releasably secure a guitar strap to the carrier in use; a leg releasably connectable at a first end to the attachment carrier and connected at a second end to a base; the base being connectable to the leg by a universal linkage; the base having an engagement surface configured to engage a musician's thigh in use; the attachment means being adapted to be releasably secured to the body of a guitar so that the weight of a guitar in use may be partially or wholly supported by the base.

The attachment carrier may include an attachment body pivotally connected to the carrier so that the body can rotate relative to the carrier. However, the attachment body may be integral with the carrier so that the guitar cannot pivot relative to the leg.

The attachment means may comprise one or more suction cups arranged to be securable to the back of a guitar body. Three suction cups may be disposed in a triangular array to provide a secure coupling using a minimal contact area. Alternatively, one or more lever operated suction cups may be employed.

Use of suction cups is advantageous because they can be attached to the guitar body at any convenient location. The attachment point may be adapted to suit a player's preference.

The optional pivot coupling between the body and carrier may be releasable. A keyhole socket and ball arrangement may be employed. Alternatively, a bearing of one component may have a bayonet or other attachment to the other component.

The attachment carrier may be disconnected from the leg in use, particularly if a player wishes to play while standing. In such an arrangement, a strap or harness may be connected to the player's body, for example, to the player's shoulders, waist or both. The strap or harness may have an attachment for engagement with the attachment body. For example, a slot in the attachment body may be dimensioned to allow a strap to run through the slot, allowing the vertical position of the guitar to be adjusted.

Such an arrangement has the advantage that conventional strap buttons are not needed, so that there is no requirement for an invasive and potentially damaging modification to the instrument. Therefore there is no additional cost to the player. The guitar's height adjustment can be achieved without removing the guitar from the strap. This provides considerable convenience for the player.

The strap or harness can be worn under the player's clothing with the singular point of contact extending through the clothing for attachment to the rear of the instrument.

In preferred embodiments, a harness comprises a belt tether arranged to be secured to a player's belt or belt loop or secured around the player's waist. A slidable strap tether may be arranged to slide along the strap and anchor the guitar at the point of attachment or at the top end of the guitar. Another strap tether may be provided with a loop to extend over existing strap buttons on guitars where these are present. This enables the strap to work with an electric bass which, with the long neck, may not have the centre of gravity at the attachment point. Because the strap is free to slide through the attachment body, the guitar can be moved to any position around a player's chest so that the guitar can be fixed in any convenient orientation in relation to the player's body.

The leg may comprise a rod having attachment means at the first end, for example, a projection dimensioned to engage a socket in the carrier. The leg is preferably arranged to extend downwardly from the attachment means towards the base so that the weight of a guitar is generally supported above the base in use. Preferably, the leg cannot move laterally relative to the carrier (and attachment body, if present). This provides more secure support for the guitar as a player moves during a performance.

The leg may be composed of two or more parts. These may be releasably coupled to allow demounting and storage for ease of transportation. In a preferred embodiment, a male to female coupling comprising a cylindrical projection and socket may be employed. Such a coupling may allow relative rotation of the two parts of the rod so that the base may be rotated relative to the attachment carrier. This arrangement may permit a player to move his leg during use of the support. Alternatively, the leg parts may be threadably engaged. A reverse thread is particularly preferred to reduce any liability for the leg parts to become unscrewed during use. Alternatively, a bayonet fitting may be employed.

The articulated linkage preferably comprises a universal joint. Less preferred linkages are two clevis joints, a ball joint or a sprung joint. The linkage allows the leg to be moved during use. This allows the player to pitch and roll naturally during a performance. A universal is preferred because it may release tension in the support, but may be easily locked against yawing movement around the vertical axis. Uncontrolled yawing may allow undesirable slewing of the base, for example down the inner side of the thigh of a user. Universal joints also allow minimal effort during movement, in contrast to a sprung joint.

A particular advantage of a universal joint is that it is relatively easy to attach to the base in such a way that the pivot is located close to the base. This gives better stability and a lower centre of gravity, reducing leverage forces on the articulated linkage. This serves to reduce the required strength of the fastening onto the base.

A universal joint has a further advantage in comparison to a ball joint or other fixtures in that the leg may be folded flat against the base for storage and transportation.

The leg may be provided with shock absorbent sleeve or coating, for example composed of foamed polymeric material, felt or absorbent textile material. The sleeve may be arranged to slide along the length of the leg having a sufficiently tight fitting to remain in place. The sleeve may serve to prevent contact of the leg with the instrument to avoid damage to the instrument or any unwanted sound in use. The sleeve may also serve as an adjustable marker so that the support can be returned to the same position without difficulty.

The sleeve may be provided with a holder for supporting another leg section. In one embodiment, the exterior surface of the sleeve may have a section with a hook and pile fastener adapted to engage a corresponding surface of the sleeve on another leg section. Alternatively, the sleeve may have a tubular section dimensioned to receive the other leg section.

The base may comprise a curved member having a radius suitable to allow comfortable engagement with a user's thigh. The base may be composed of wood or other suitable material and may be rectangular, elliptical or oval in shape. This simple construction has the advantage of robustness and does not detract from the appearance of the guitar.

In an alternative embodiment, the base may comprise two separate hinged or articulated feet attached to a connecting arm.

The leg engaging surface of the base may be coated with a suitable rubber, polymeric or other high friction material.

In alternative embodiments to the invention, the leg is provided with a leg extension member having a length so that the base may be located in engagement with a floor surface.

The strap may be a single strap or may comprise two components.

A single strap length or two lengths joined in the middle of a suitable material may have a keyhole fastener to allow the strap to be releasably secured to the attachment body. A stabilising tab of suitable material may hang downwardly from the keyhole slot to assist in steadying the strap while fitting and removing a guitar.

The strap may be fitted with a disc of aluminium or other lightweight metal which may be provided with a horizontal slot to receive the strap. A disc-shaped body is preferred to reduce the risk of snagging in the attachment body and strap when the guitar is played. Preferably the disc is free to slide from side to side along the strap. The strap may be arranged to fit over a player's shoulders in a comfortable manner allowing the strap to be tucked or hitched onto a player's belt as convenient.

The invention is further described by means of example, but not in any limitative sense, with reference to the accompanying drawings, of which:

### BRIEF DESCRIPTION OF THE DRAWINGS

FIG. 1 shows a guitar support in accordance with the present invention;

FIG. 2 is a cross-sectional view of the support;

FIG. 3 is a sketch showing the guitar support in use by a flamenco-style player; and

FIG. 4 shows a player wearing the strap.

### DETAILED DESCRIPTION OF THE INVENTION

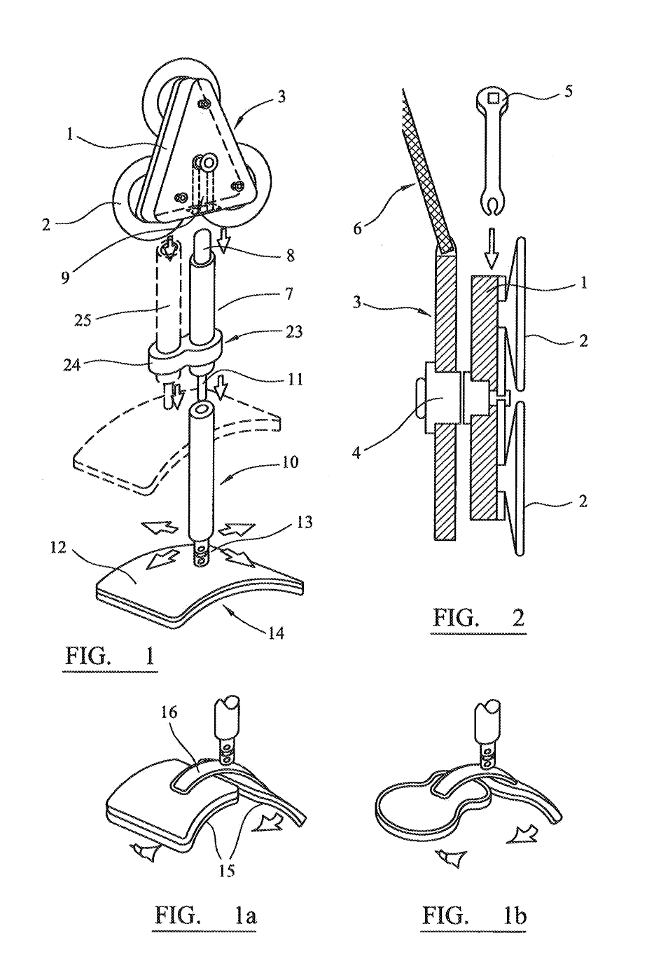

The guitar support shown in FIGS. 1 and 2 comprises a generally triangular attachment carrier (1) having three attachment means extending outwardly to engage the body of a guitar (not shown). The attachment means comprise suction cups. In an alternative embodiment, one or more suction cups may be provided with overcentre lever arrangements to ensure a strong suction grip. An attachment body (3) is coupled to the carrier (1). The body (3) may be formed integrally with the carrier (1) and may be fastened to it , for example by screws or adhesive. Alternatively, the body (3) may be coupled to the carrier (1) by means of a pivotal linkage (4) so that the carrier (1) may rotate relative to the body (3). The pivotal linkage may comprise a bearing and bayonet fitting, keyhole and ball arrangement or other convenient rotatable means. An escutcheon pin (5) serves to lock the carrier to the body in use.

A strap (6) secured to the body (3) extends around a player's neck and shoulders in a conventional manner.

A leg (7) has an axially extending peg (8) adapted to be received in a corresponding socket (9) in the body (3). A lower leg member (10) is releasably connectable to the upper leg member (7) by means of a male to female connector (11). The connector (11) comprises an axially extending projection and corresponding socket to permit the lower leg member (10) to rotate relative to the upper leg member in use. The socket (11) may be configured to allow rotation through a limited angle, for example a maximum of 30 degrees, preferably 20 degrees.

A sleeve (23) is mounted on the leg and is slidable along the leg. The sleeve, formed of foamed polymeric material, felt or quilted textile, serves to provide a shock absorbing cushion preventing damage to the guitar body. The sleeve (23) may be provided with a further sleeve (24) which may be either integral or connected with a releasable fastening, for example, a hook and pile fastener, so that the second leg member (10) may be installed as shown at (25) in dotted lines.

The lower leg (10) is connected to a base (12) by means of an articulated linkage (13). The articulated linkage comprises a universal joint. Preferably the linkage (13) is located as close to the surface of the base (12) to reduce twisting and bending forces on the attachment to the base in use.

The lower surface (14) of the base (12) may be coated with rubbery or polymeric low friction material. The base (12) may have a part cylindrical configuration with a radius suitable for comfortable engagement with a user's thigh.

In an alternative embodiment shown in FIG. 1 a, the base comprises two feet (15) connected to the articulated linkage (13) by means of legs (16). The feet may be rectangular, as shown in FIG. 1a, or curved as shown in FIG. 1b, to provide optimal comfort for a user.

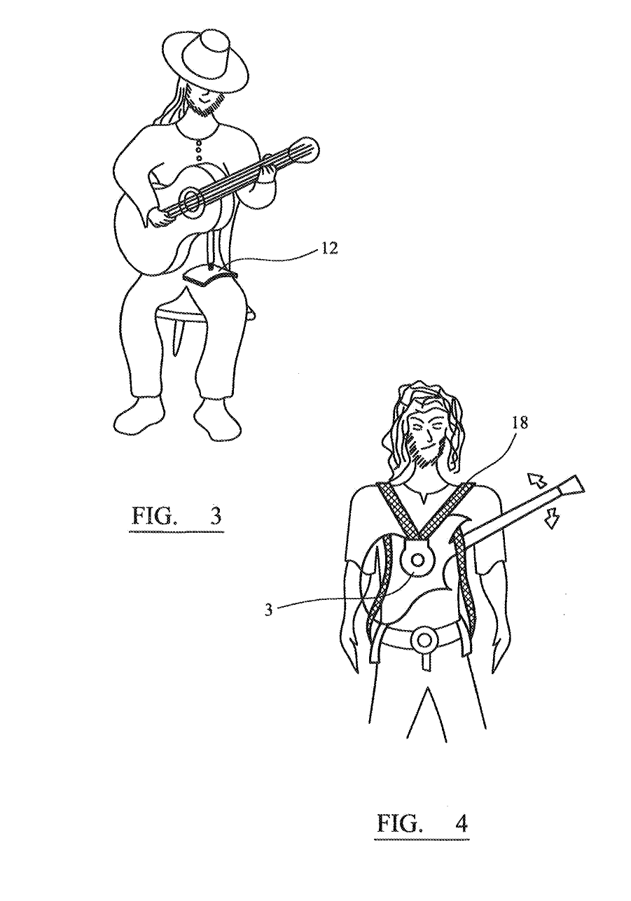

FIG. 3 shows the support in use by a flamenco-style player. The suction cups (2) are secured to the back of the guitar (not shown) and the base (12) engages on a user's left thigh.

FIG. 4 shows straps (18) attached to the attachment body (3) for use without the support. The straps (18) are attached to the attachment body (3) by means of a pivotal linkage enabling the orientation of the guitar to be adjusted in use. In an alternative embodiment, the straps (18) may be worn beneath the player's shirt or other clothing and attached to the player's belt, allowing vertical adjustment of the guitar location.

1. A guitar support comprising an attachment carrier and one or more releasable attachment means;
the attachment carrier having a fixture adapted to releasably secure a guitar strap to the carrier in use;
a leg releasably connectable at a first end to the attachment carrier and connectable at a second end to a base;
the base being connectable to the leg by an articulated linkage;
the base having an engagement surface configured to engage a musician's thigh in use;
the attachment means being adapted to be releasably secured to the body of a guitar so that the weight of a guitar in use may be partially or wholly supported by the base.

2. A guitar support as claimed in claim 1, wherein the articulated linkage is a universal linkage.

3. A guitar support as claimed in claim 1, wherein the attachment means comprises one or more suction cups.

4. A guitar support as claimed in any previous claim, further comprising an attachment body pivotally connected to the carrier so that the carrier can rotate relative to the body.

5. A guitar support as claimed in any preceding claim, wherein the pivot coupling between the body and carrier is releasable.

6. A guitar support as claimed in any preceding claim, wherein the leg comprises two parts releasably coupled.

7. A guitar support as claimed in any preceding claim, comprising a sleeve slidable along the leg.

8. A guitar support as claimed in any preceding claim, wherein the base comprises a curved member.

9. A guitar support as claimed in any preceding claim, further comprising a leg extension member.

10. A guitar support substantially as hereinbefore described and with reference to the accompanying drawings.
